(19) United States
(12) Patent Application Publication
(10) Pub. No.: US 2023/0013078 A1
(43) Pub. Date: Jan. 19, 2023

(54) SELF-SERVICE TERMINAL AND METHOD FOR OPERATING A SELF-SERVICE TERMINAL

(71) Applicant: Wincor Nixdorf International GmbH, Paderborn (DE)

(72) Inventors: Eduard WEIS, Paderborn (DE); Alexander KNOBLOCH, Paderborn (DE); Sebastian ENGELNKEMPER, Langenberg (DE)

(21) Appl. No.: 17/786,220

(22) PCT Filed: Dec. 9, 2020
(86) PCT No.: PCT/EP2020/085255

§ 371 Date: Jun. 16, 2022

(30) Foreign Application Priority Data
Dec. 17, 2019 (EP) 19217170.0

(51) Int. Cl. G06V 40/50; G06Q 20/18; G06Q 20/40; G06T 7/00; G06V 10/22; G06V 40/16; G06V 10/26

(52) U.S. Cl. CPC G06V 40/50; G06Q 20/18; G06Q 20/40145; G06T 7/0002; G06V 10/22; G06V 40/166; G06V 40/172; G06V 10/26; G07F 19/207

(57) ABSTRACT

A self-service terminal (100) and a method (300, 600) for operating a self-service terminal are disclosed, wherein the self-service terminal (100) comprises: an imaging device (102), configured for providing at least one digital image (104); at least one processor (110), configured for: determining whether the at least one digital image (104) comprises a face of a person; if the at least one digital image (104) comprises the face of the person, cutting out from the at least one digital image (104) an image region which comprises the face of the person; and a storage device (108), configured for storing the image region.

### BACKGROUND

Various exemplary embodiments relate to a self-service terminal and to a method for operating a self-service terminal.

At a self-service terminal, such as an automated teller machine, for example, a user can take advantage of various services without interaction with an additional person. In this case, it may be necessary for a verification to be available afterward in order to confirm or prove an interaction carried out by the user. By way of example, it may be necessary to prove that a user has withdrawn money at an automated teller machine. For this purpose, by way of example, image data can be recorded during the use of the self-service terminal. Since this requires high storage capacities, only individual images are stored. However, it may happen that the user is not unambiguously recognizable in the stored individual images, with the result that the interaction carried out by the user cannot be confirmed. Therefore, it may be necessary to store image data which reliably enable identification of the user. Furthermore, in order to increase the storage efficiency, it may be necessary to reduce the quantity of data to be stored.

### SUMMARY

In accordance with various embodiments, a self-service terminal and a method for operating a self-service terminal are provided which are able to confirm, in particular retrospectively confirm a user of a self-service terminal.

In accordance with various embodiments, a self-service terminal comprises: an imaging device, configured for providing at least one digital image; at least one processor, configured for: determining whether the at least one digital image comprises a face of a person; if the at least one digital image comprises the face of the person, cutting out from the at least one digital image an image region which comprises the face of the person; and a storage device, configured for storing the image region.

The self-service terminal having the features of independent claim 1 forms a first example.

Cutting out the image region from a digital image and storing the image region instead of the digital image has the effect that the quantity of data to be stored is reduced. Furthermore, this has the effect of ensuring that only data which show the face of a person are stored. The stored image region can be communicated from the self-service terminal to an external server (for example a storage device of an external server), for example communicated via a local network (e.g. LAN) or a global network (e.g. GAN, e.g. Internet). In this case, it furthermore has the effect that the quantity of data to be communicated is reduced.

The self-service terminal can comprise at least one imaging sensor. The at least one imaging sensor can be a camera sensor and/or a video camera sensor. The features described in this paragraph in combination with the first example form a second example.

The at least one processor can furthermore be configured to discard the at least one digital image if the at least one digital image does not comprise a face of a person. The feature described in this paragraph in combination with the first example or the second example forms a third example.

The at least one processor can furthermore be configured, if the at least one digital image comprises the face of the person, to determine whether the cut-out image region satisfies a predefined criterion. The predefined criterion can be a predefined image quality criterion and/or a predefined recognizability criterion. The at least one processor can furthermore be configured to store the cut-out image region only if the cut-out image region satisfies the predefined criterion. This has the effect that the quantity of data to be stored is additionally reduced. Furthermore, this has the effect of ensuring that the face represented in the image region is recognizable. The features described in this paragraph in combination with one or more of the first example to the third example form a fourth example.

The at least one processor can furthermore be configured to discard the image region if the cut-out image region does not satisfy the predefined image quality criterion and/or does not satisfy the predefined recognizability criterion. The feature described in this paragraph in combination with the fourth example forms a fifth example.

The image quality criterion of the image region can comprise at least one of the following parameters: sharpness, brightness, contrast. The image quality criterion of the image region can comprise additional quantifiable image quality features. The features described in this paragraph in combination with the fourth example or the fifth example form a sixth example.

The recognizability criterion can comprise the recognizability of the face of the person in the image region. The recognizability criterion can comprise at least one of the following parameters: degree of concealment of the face, viewing angle. The recognizability criterion can comprise additional quantifiable features which hamper, for example prevent, the identification of a person. The features described in this paragraph in combination with one or more of the fourth example to the sixth example form a seventh example.

The self-service terminal can be an automated teller machine, a self-service check out or a self-service kiosk. The features described in this paragraph in combination with one or more of the first example to the seventh example form an eighth example.

The storage device can be configured to store the image region of the at least one digital image in an image database. The feature described in this paragraph in combination with one or more of the first example to the eighth example forms a ninth example.

The storage device can furthermore be configured to store a time of day at which the image was detected by means of the imaging device and/or a procedure number assigned to the image region in conjunction with the image region in the image database. The features described in this paragraph in combination with the ninth example form a tenth example.

The procedure number can be a bank transaction number.

The feature described in this paragraph in combination with the tenth example forms an eleventh example.

The at least one processor can be configured to determine by means of a facial recognition algorithm whether the at least one digital image comprises a face of a person. The feature described in this paragraph in combination with one or more of the first example to the eleventh example forms a twelfth example.

The at least one digital image can be a sequence of digital images. The feature described in this paragraph in combination with one or more of the first example to the twelfth example forms a thirteenth example.

The at least one processor can be configured to process the sequence of images and to provide a sequence of image regions, and the storage device can be configured to store the sequence of image regions. The features described in this paragraph in combination with the thirteenth example form a fourteenth example.

The storage device can comprise a non-volatile memory for storing the image region of the at least one digital image. The feature described in this paragraph in combination with one or more of the first example to the fourteenth example forms a fifteenth example.

A method for operating a self-service terminal can comprise: detecting at least one digital image; determining whether the at least one digital image comprises a face of a person; if the at least one digital image comprises the face of the person, cutting out from the at least one digital image an image region which comprises the face of the person; and storing the cut-out image region of the at least one digital image. The method described in this paragraph forms a sixteenth example.

The cut-out image region of the at least one digital image can be stored in a non-volatile memory. The feature described in this paragraph in combination with the sixteenth example forms a seventeenth example.

A method for operating a self-service terminal can comprise: detecting at least one digital image; determining whether the at least one digital image comprises a face of a person; if the at least one digital image comprises the face of the person, cutting out from the at least one digital image an image region which comprises the face of the person; determining whether the cut-out image region satisfies a predefined criterion; and storing the cut-out image region of the at least one digital image if the cut-out image region satisfies the predefined criterion. The method described in this paragraph forms an eighteenth example.

The cut-out image region which satisfies the predefined criterion can be stored in a non-volatile memory. The feature described in this paragraph in combination with the eighteenth example forms a nineteenth example.

### BRIEF DESCRIPTIONS OF THE DRAWINGS

In the figures:

FIG. 1 shows a self-service terminal in accordance with various embodiments;

FIG. 2 shows an image processing system in accordance with various embodiments;

FIG. 3 shows a method for operating a self-service terminal in accordance with various embodiments;

FIG. 4 shows a temporal sequence of image processing in accordance with various embodiments;

FIG. 5 shows an image processing system in accordance with various embodiments;

FIG. 6 shows a method for operating a self-service terminal in accordance with various embodiments;

FIG. 7 shows a temporal sequence of image processing in accordance with various embodiments.

### DETAILED DESCRIPTION

In the following detailed description, reference is made to the accompanying drawings, which form part of this description and show for illustration purposes specific embodiments in which the invention can be implemented.

The term “processor” can be understood as any type of entity which allows data or signals to be processed. The data or signals can be handled for example in accordance with at least one (i.e. one or more than one) specific function executed by the processor. A processor can comprise or be formed from an analog circuit, a digital circuit, a mixed-signal circuit, a logic circuit, a microprocessor, a central processing unit (CPU), a graphics processing unit (GPU), a digital signal processor (DSP), a programmable gate array (FPGA), an integrated circuit or any combination thereof. Any other type of implementation of the respective functions described more thoroughly below can also be understood as a processor or logic circuit. It is understood that one or more of the method steps described in detail herein can be implemented (e.g. realized) by a processor, by means of one or more specific functions executed by the processor. The processor can therefore be configured to carry out one of the methods described herein or the components thereof for information processing.

Various embodiments relate to a self-service terminal and a method for operating a self-service terminal. From a temporal standpoint following use of a self-service terminal by a user, it may be necessary to identify the user. Illustratively, a self-service terminal and a method are provided which are able to ensure, for example retrospectively, identification of a user.

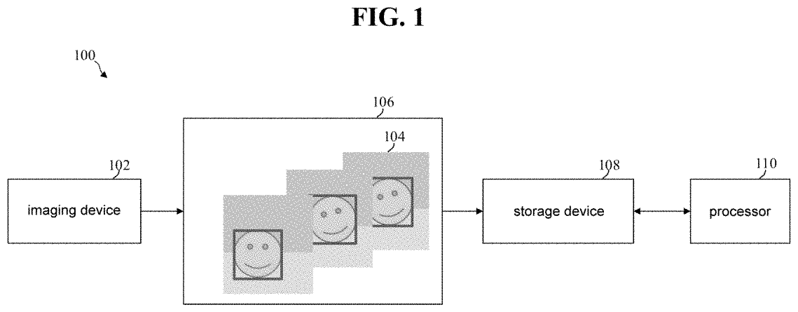

FIG. 1 illustrates a self-service terminal 100 in accordance with various embodiments. The self-service terminal 100 can be an automated teller machine (a cash machine), a self-service checkout or a self-service kiosk. The self-service terminal 100 can comprise an imaging device 102. The imaging device 102 can be configured to provide at least one digital image 104, for example to provide a plurality of digital images 106. The imaging device 102 can comprise one or more sensors. The one or more sensors can be configured to provide digital data. The imaging device 102 can be configured to provide the at least one digital image 104 or the plurality of digital images 106 using the digital data provided. In accordance with various embodiments, the digital data comprise digital image data. The one or more sensors can be imaging sensors, such as, for example, a camera sensor or a video sensor. The sensors of the plurality of sensors can comprise the same type or different types of sensors. The imaging device 102 can be configured to detect the digital data or the at least one digital image 104 in reaction to an event. The self-service terminal can comprise one or more motion sensors, for example, and the triggering event can be a movement detected by means of the one or more motion sensors.

The self-service terminal can comprise an operating device configured to enable a person, such as a user, for example, to operate the self-service terminal, wherein the event can be an event triggered by the user, for example entry of a PIN at an automated teller machine, selection at a self-service kiosk, selecting or inputting a product at a self-service checkout, etc.

The self-service terminal 100 can furthermore comprise a storage device 108. The storage device 108 can comprise at least one memory. The memory can be used for example during the processing carried out by a processor. A memory used in the embodiments can be a volatile memory, for example a DRAM (dynamic random access memory), or a non-volatile memory, for example a PROM (programmable read only memory), an EPROM (erasable PROM), an EEPROM (electrically erasable PROM) or a flash memory, such as, for example, a floating gate memory device, a charge trapping memory device, an MRAM (magnetoresistive random access memory) or a PCRAM (phase change random access memory). The storage device 108 can be configured to store digital images, such as, for example, the at least one digital image 104 or the plurality of digital images 106.

The self-service terminal 100 can furthermore comprise at least one processor 110. The at least one processor 110 can be, as described above, any type of circuit, i.e. any type of logic-implementing entity. The processor 110 can be configured to process the at least one digital image 104 or the plurality of digital images 106.

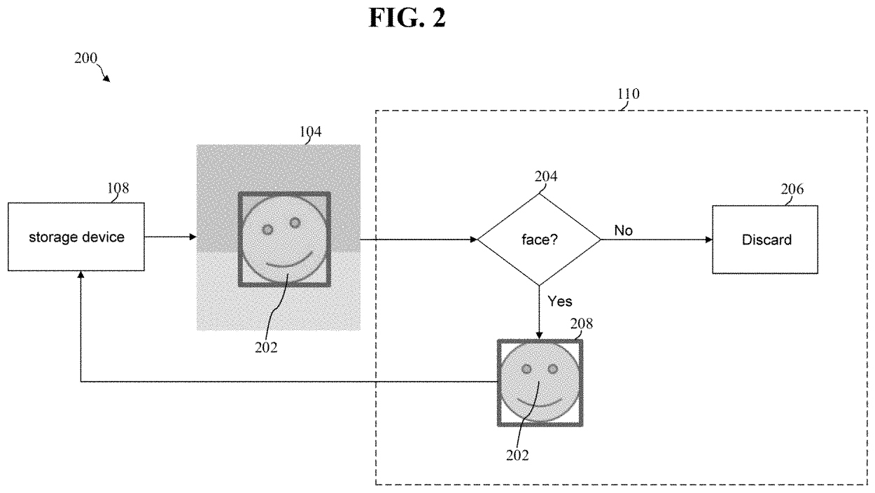

FIG. 2 illustrates an image processing system 200 in accordance with various embodiments. The image processing system 200 can comprise the storage device 108. The storage device 108 can be configured to store digital images, such as, for example, the digital image 104 or the plurality of digital images 106. The image processing system 200 can furthermore comprise the at least one processor 110. The storage device 108 can be configured to provide the processor 110 with the at least one digital image 104 and the processor 110 can be configured to process the at least one digital image 104.

The at least one digital image 104 can comprise a face 202 of a person. The processor 110 can be configured for determining 204 whether the at least one digital image 104 comprises a face 202 of a person. Determining 204 whether the at least one digital image 104 comprises a face 202 of a person can comprise using a facial recognition method, for example a facial recognition algorithm. The facial recognition method can be a biometric facial recognition method. The facial recognition method can be a two-dimensional facial recognition method or a three-dimensional facial recognition method. The facial recognition method can be carried out using a neural network. The processor 110 can furthermore be configured, if the at least one digital image 104 comprises the face 202 of the person, to cut out an image region 208 from the at least one digital image 104, wherein the image region 208 can comprise the face 202 of the person.

The storage device 108 can furthermore be configured to store the image region 208. As described above, the storage device 108 can be a non-volatile memory. In accordance with various embodiments, the image region 208 of the at least one digital image 104 is stored in the non-volatile memory. The storage device 108 can be configured to store the image region 208 of the at least one digital image 104 in an image database. The storage device 108 can furthermore be configured to store a time of day at which the at least one digital image 104 assigned to the image region 208 was detected by means of the imaging device 208 in conjunction with the image region 208 in the image database. The storage device 108 can furthermore be configured to store a procedure number assigned to the image region 208 in conjunction with the image region 208 in the image data base. The procedure number can be a bank transaction number, for example.

The processor 110 can furthermore be configured, if the at least one digital image 104 does not comprise a face 202 of a person, to discard 206 the at least one digital image 104, for example to erase the latter (that is to say that the processor 110 can be configured to communicate a command to the storage device 108, and the storage device 108 can be configured to erase the at least one digital image 104 in reaction to the command). To put it another way, the storage device 108 can store, for example volatilely store, the at least one digital image 104 provided by the imaging device, and the processor 110 can discard 206 or erase the stored, for example volatilely stored, at least one digital image 104 if the processor determines that the at least one digital image 104 does not comprise a face 202 of a person, and the processor can cut out an image region 208 from the at least one digital image 104 if it determines that the at least one digital image 104 comprises a face 202 of a person, and the processor can furthermore store, for example nonvolatilely store, the image region 208 in the storage device 108. The processor 110 can furthermore be configured to discard the at least one digital image 104, for example to erase the latter (that is to say that the processor 110 can communicate a command to the storage device 108 and the storage device 108 can erase the at least one digital image 104 in reaction to the command), after the cut-out image region 208 has been stored, for example nonvolatilely stored, in the storage device 108.

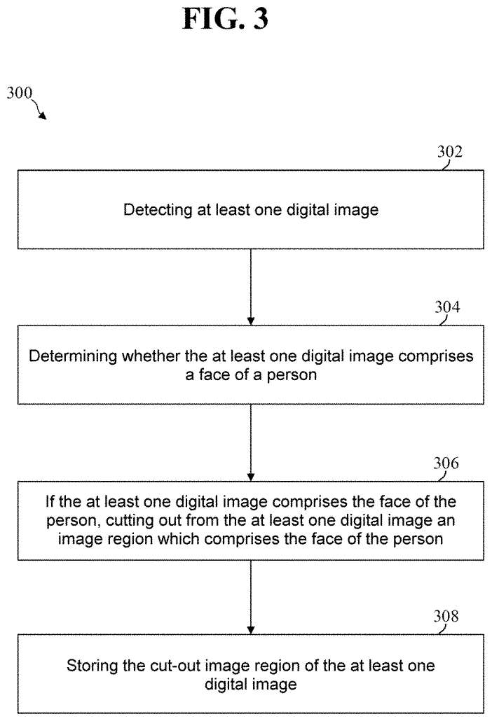

FIG. 3 illustrates a method 300 for operating a self-service terminal 100 in accordance with various embodiments. The method 300 can comprise detecting at least one digital image 104 (in 302). The at least one digital image 104 can be detected by means of the imaging device 102. In accordance with various embodiments, the imaging device 102 comprises at least one imaging sensor, such as, for example, a camera sensor or a video sensor, for detecting at least one digital image 104. The method 300 can furthermore comprise: determining 204 whether the at least one digital image 104 comprises a face 202 of a person (in 304). The method 300 can furthermore comprise: if the at least one digital image 104 comprises the face 202 of the person, cutting out an image region 208 from the at least one digital image 104 (in 306), wherein the image region 208 can comprise the face 202 of the person. The method 300 can furthermore comprise storing the cut-out image region 208 of the at least one digital image 104 (in 308). The cut-out image region 208 can be stored in a non-volatile memory of the storage device 108.

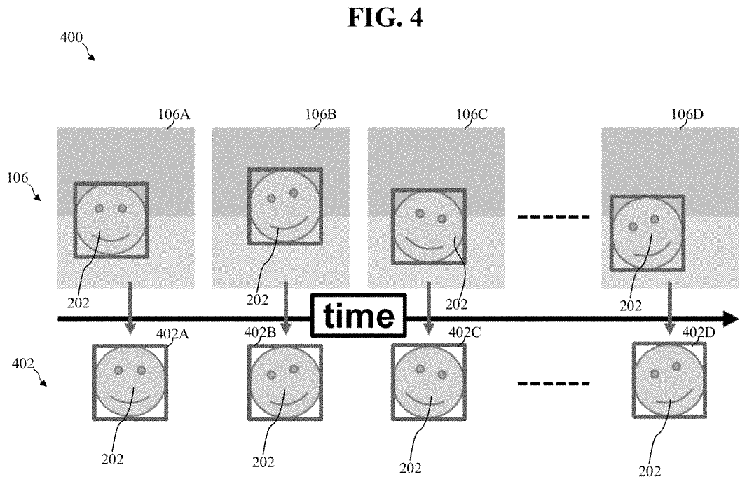

FIG. 4 illustrates a temporal sequence 400 of image processing in accordance with various embodiments. The imaging device 102 can be configured to provide a plurality of digital images 106 and the storage device 108 can be configured to store the plurality of digital images 106. The plurality of digital images 106 can comprise for example a first digital image 106A, a second digital image 106B, a third digital image 106C and a fourth digital image 106D. The first digital image 106A, the second digital image 106B, the third digital image 106C and/or the fourth digital image 106D can comprise a face 202 of a person. The first digital image 106A, the second digital image 106B, the third digital image 106C and the fourth digital image 106D can be detected at different points in time by means of the imaging device 102. By way of example, the second digital image 106B can be detected temporally after the first digital image 106A, the third digital image 106C can be detected temporally after the second digital image 106B, and the fourth digital image 106D can be detected temporally after the third digital image 106C. To put it another way, the plurality of digital images 106 can be detected successively. The plurality of digital images 106 can be a sequence of digital images and the at least one processor 110 can be configured to process the sequence of digital images. To put it another way, the processor 110 can be configured to process each digital image of the plurality of digital images 106. The sequence of images can be a video stream, for example. The processor 110 can be configured to process each digital image of the plurality of digital images 106 according to the method 300. That is to say that the processor 110 can be configured to determine for each digital image of the plurality of digital images 106 whether the respective digital image comprises a face 202 of a person, and, if the respective digital image comprises the face 202 of the person, to cut out an image region 208 from the respective digital image, wherein the respective image region 208 comprises the face 202 of the person. Consequently, if the first digital image 106A, the second digital image 106B, the third digital image 106C and the fourth digital image 106D comprise a face 202 of a person, the processor 110 can provide a first image region 402A for the first digital image 106A, a second image region 402B for the second digital image 106B, a third image region 402C for the third digital image 106C and a fourth image region 402D for the fourth digital image 106D. The storage device 108 can be configured to store, for example nonvolatilely store, the first image region 402A, the second image region 402B, the third image region 402C and the fourth image region 402D.

That is to say that the processor 110 can be configured to provide a sequence of image regions for a sequence of digital images and the storage device 108 can be configured to store the sequence of image regions.

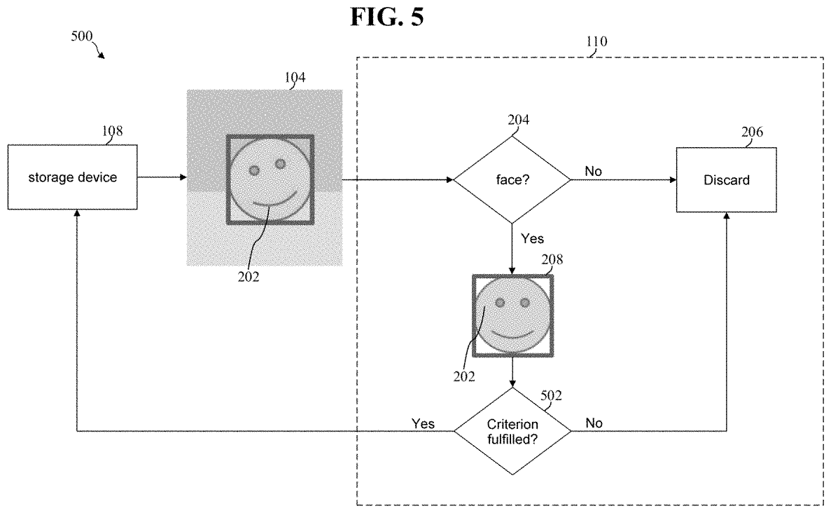

FIG. 5 illustrates an image processing system 500 in accordance with various embodiments. The image processing system 500 can substantially correspond to the image processing system 200, wherein the processor 110 can furthermore be configured to determine whether the cut-out image region 208 of the at least one digital image 104 satisfies a predefined criterion 502. The processor 110 can be configured for determining whether the cut-out image region 208 satisfies a predefined criterion 502 (i.e. whether a predefined criterion 502 is fulfilled) before the image region 208 is stored in the storage device 108. The predefined criterion 502 can be an image quality criterion. The image quality criterion can comprise at least one of the following parameters: a sharpness, a brightness, a contrast. That is to say that the image quality criterion can comprise for example a minimum required sharpness, a minimum required brightness, a maximum allowed brightness and/or a minimum required contrast. The sharpness may be greatly reduced for example on account of motion blur. The predefined criterion 502 can be a recognizability criterion. The recognizability criterion can comprise a recognizability of a face 202 of a person in an image region 208. That is to say that the recognizability criterion can indicate whether or how well the face 202 of the person is able to be recognized. The recognizability criterion can comprise at least one of the following parameters: degree of concealment of the face 202, viewing angle. To put this another way, the recognizability criterion indicates whether a person can be identified on the basis of the image region 208. The degree of concealment of the face 202 can indicate what percentage and/or which regions of the face 202 are concealed and the recognizability criterion can indicate what percentage of the face 202 must not be concealed and/or which regions of the face 202 must not be concealed. The viewing angle can indicate the angle at which the face 202 is inclined or rotated in relation to an imaging sensor, such as a camera or a video camera, for example, and the recognizability criterion can indicate the permitted magnitude of the angle between the imaging sensor and the face 202. To put it another way, the viewing angle can indicate whether the face 202 (for example the complete face) is recognizable by the imaging sensor).

In accordance with various embodiments, the predefined criterion 502 comprises the image quality criterion and the recognizability criterion. The storage device 108 can be configured to store the image region 208 of the at least one digital image 104 if the cut-out image region 208 satisfies the predefined criterion 502 (i.e. the image quality criterion and/or the recognizability criterion) (that is to say that the predefined criterion 502 is fulfilled, “Yes”). The storage device 108 can be configured to store the image region 208 in a non-volatile memory.

The processor 110 can furthermore be configured, if the image region 208 does not satisfy the predefined criterion 502 (i.e. does not satisfy the image quality criterion and/or does not satisfy the recognizability criterion), to discard 206 the image region 208, for example to erase the latter (that is to say that the processor 110 can be configured to communicate a command to the storage device 108, and the storage device 108 can be configured to erase the image region 208 in reaction to the command). To put it another way, the storage device 108 can store, for example volatilely store, the at least one digital image 104 and the cut-out image region 208, and the processor 110 can discard 206 or erase the stored, for example volatilely stored, image region 208 if the processor determines that the image region 208 does not fulfil the predefined criterion 502.

In accordance with various embodiments, the imaging device 102 can provide a plurality of digital images 106 and the processor 110 can be configured to determine 204 for each digital image of the plurality of digital images 106 whether the respective digital image comprises a face of a person. The processor 110 can furthermore be configured to cut out an image region from each digital image which shows a face of a person, wherein the image region can comprise the respective face of the respective person. The processor 110 can furthermore be configured to determine for each cut-out image region of the plurality of cut-out image regions whether the predefined criterion 502 is fulfilled. If the predefined criterion 502 is not fulfilled for any cut-out image region of the plurality of cut-out image regions or if the number of cut-out image regions of the plurality of cut-out image regions which fulfil the predefined criterion 502 is smaller than a predefined number, the processor 110 can be configured to determine an assessment (for example by assigning a number representing a measure of the assessment), such as an image quality assessment, for example, for each cut-out image region of the plurality of cut-out image regions. The processor 110 can be configured to select the cut-out image regions of the plurality of image regions which have the highest assessment or the highest assessments (for example the largest assigned number or the largest assigned numbers) and to store them in the storage device 108. The number of selected cut-out image regions having the highest assessments can correspond to the predefined number. The number of selected cut-out image regions having the highest assessments can correspond to a predefined selection number, wherein the predefined selection number can be greater than the predefined number. In accordance with various embodiments, the imaging device 102 can be configured to provide an additional digital image, wherein the additional digital image can be provided from a temporal standpoint following the storage of the selected digital image regions. The processor 110 can determine that the additional digital image comprises a face of a person and can cut out an additional image region from the additional digital image. The processor 110 can furthermore determine that the additional image region fulfils the predefined criterion 502 or that the additional image region has a higher assessment (i.e. a larger assigned number) than at least one stored image region of the plurality of stored image regions. The processor 110 can be configured to store the additional image region in the storage device 108. The processor 110 can furthermore be configured to erase a stored image region of the plurality of stored image regions if this stored image region has a lower assessment (i.e. a smaller assigned number) than the additional image region. That has the effect of ensuring that at least one cut-out image region which shows a face of a person is stored independently of the image quality. Furthermore, it ensures that the at least one stored image region has the best available image quality, i.e. the best image quality of the plurality of image regions of the plurality of detected digital images.

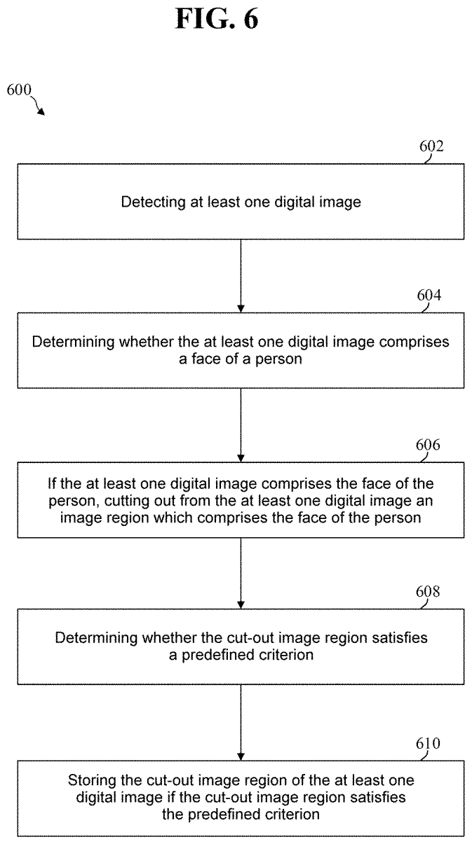

FIG. 6 illustrates a method 600 for operating a self-service terminal 100 in accordance with various embodiments. The method 600 can comprise detecting at least one digital image 104 (in 602). The at least one digital image 104 can be detected by means of the imaging device 102. In accordance with various embodiments, the imaging device 102 comprises at least one imaging sensor, such as a camera sensor or a video sensor, for example, for detecting at least one digital image 104. The method 600 can furthermore comprise: determining 204 whether the at least one digital image 104 comprises a face 202 of a person (in 604). The method 600 can furthermore comprise: if the at least one digital image 104 comprises the face 202 of the person, cutting out an image region 208 from the at least one digital image 104 (in 606), wherein the image region 208 can comprise the face 202 of the person. The method 600 can furthermore comprise determining whether the cut-out image region 208 satisfies a predefined criterion 502 (in 608). The predefined criterion 502 can be an image quality criterion comprising a sharpness, a brightness and/or a contrast, for example. The predefined criterion 502 can be a recognizability criterion comprising a recognizability of a face 202 of a person in an image region 208. The criterion 502 can comprise the image quality criterion and the recognizability criterion. The method 600 can furthermore comprise storing the cut-out image region 208 of the at least one digital image 104 if the cut-out image region 208 satisfies the predefined criterion 502, i.e. fulfils the predefined criterion 502 (in 610). The cut-out image region 208 can be stored in a non-volatile memory of the storage device 108.

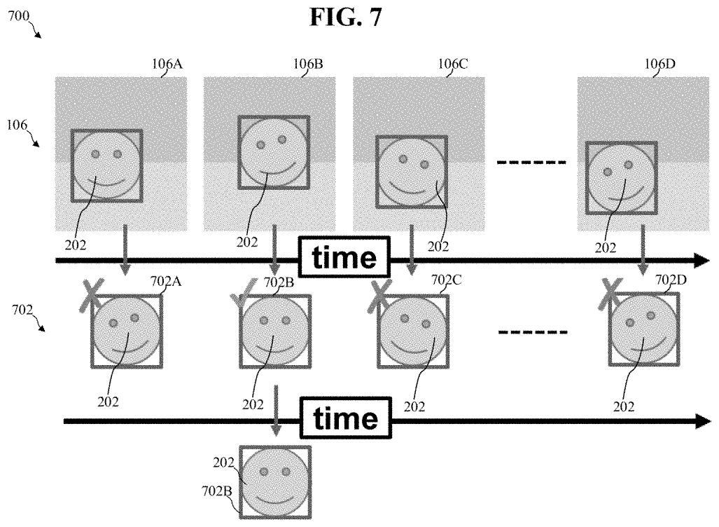

FIG. 7 illustrates a temporal sequence 700 of image processing in accordance with various embodiments. The imaging device 102 can be configured to provide a plurality of digital images 106 and the storage device 108 can be configured to store the plurality of digital images 106. The plurality of digital images 106 can comprise for example a first digital image 106A, a second digital image 106B, a third digital image 106C and a fourth digital image 106D. The first digital image 106A, the second digital image 106B, the third digital image 106C and/or the fourth digital image 106D can comprise a face 202 of a person. The first digital image 106A, the second digital image 106B, the third digital image 106C and the fourth digital image 106D can be detected at different points in time by means of the imaging device 102. By way of example, the second digital image 106B can be detected temporally after the first digital image 106A, the third digital image 106C can be detected temporally after the second digital image 106B, and the fourth digital image 106D can be detected temporally after the third digital image 106C. To put it another way, the plurality of digital images 106 can be detected successively. The plurality of digital images 106 can be a sequence of digital images and the at least one processor 110 can be configured to process the sequence of digital images. To put it another way, the processor 110 can be configured to process each digital image of the plurality of digital images 106. The processor 110 can be configured to process each digital image of the plurality of digital images 106 according to the method 600. That is to say that the processor 110 can be configured to determine for each digital image of the plurality of digital images 106 whether the respective digital image comprises a face 202 of a person, and, if the respective digital image comprises the face 202 of the person, to cut out an image region 208 from the respective digital image, wherein the respective image region 208 comprises the face 202 of the person. Consequently, if the first digital image 106A, the second digital image 106B, the third digital image 106C and the fourth digital image 106D comprise a face 202 of a person, the processor 110 can provide a first image region 702A for the first digital image 106A, a second image region 702B for the second digital image 106B, a third image region 702C for the third digital image 106C and a fourth image region 702D for the fourth digital image 106D. The processor 110 can furthermore be configured, in accordance with the method 600, to determine for each cut-out image region of the plurality of cut-out image regions (702A, 702B, 702C, 702D) whether the cut-out image region (702A, 702B, 702C, 702D) satisfies a predefined criterion 502, i.e. whether the predefined criterion 502 is fulfilled, wherein the predefined criterion 502 can be for example an image quality criterion and/or a recognizability criterion. The storage device 108 can be configured to store a cut-out image region of the plurality of image regions (702A, 702B, 702C, 702D) if the respective image region satisfies the predefined criterion 502, wherein the storage device 108 can be configured to store the respective image region in a non-volatile memory.

The processor 110 can furthermore be configured, if a respective image region does not satisfy the predefined criterion 502 (i.e. does not satisfy the image quality criterion and/or does not satisfy the recognizability criterion), to discard the image region, for example to erase the latter (that is to say that the processor 110 can be configured to communicate a command to the storage device 108, and the storage device 108 can be configured to erase the at least one digital image 104 in reaction to the command). To put it another way, the storage device 108 can store, for example volatilely store, the at least one digital image 104 and the respective cut-out image region, and the processor 110 can discard or erase the stored, for example volatilely stored, image region if the processor determines that the image region does not fulfil the predefined criterion 502.

As shown illustratively in FIG. 7, by way of example, it may be the case that the first image region 702A, the third image region 702C and the fourth image region 702D do not fulfil the predefined criterion 502 and the second image region 702B can fulfil the predefined criterion 502 and the storage device 108 can be configured to store, for example nonvolatilely store, the second image region 702B. The processor 110 can be configured to discard the first image region 702A, the third image region 702C and the fourth image region 702D or the storage device 108 can erase the first image region 702A, the third image region 702C and the fourth image region 702D.

1. A self-service terminal (100), comprising:
an imaging device (102), configured for providing at least one digital image (104);
at least one processor (110), configured for:
determining whether the at least one digital image (104) comprises a face of a person;
if the at least one digital image (104) comprises the face of the person, cutting out from the at least one digital image (104) an image region which comprises the face of the person; and
a storage device (108), configured for storing the image region.

2. The self-service terminal (100) as claimed in claim 1, wherein the at least one processor (110) is furthermore configured for: discarding the at least one digital image (104) if the at least one digital image (104) does not comprise a face of a person.

3. The self-service terminal (100) as claimed in either of claims 1 and 2, wherein the at least one processor (110) is furthermore configured for:
if the at least one digital image (104) comprises the face of the person, determining whether the cut-out image region satisfies a predefined criterion; and
storing the image region only if the cut-out image region satisfies the predefined criterion.

4. The self-service terminal (100) as claimed in claim 3, wherein the at least one processor (110) is furthermore configured for: discarding the image region if the cut-out image region does not satisfy the predefined criterion, or wherein the at least one processor (110) is configured for: selecting the image region using an image quality assessment and storing the selected image region.

5. The self-service terminal (100) as claimed in either of claims 3 and 4, wherein the predefined criterion comprises a predefined image quality criterion of the image region and wherein the predefined image quality criterion optionally comprises at least one of the following parameters: sharpness, brightness, contrast.

6. The self-service terminal (100) as claimed in any of claims 3 to 5, wherein the predefined criterion comprises a predefined recognizability criterion comprising the recognizability of the face of the person in the image region, and wherein optionally the recognizability criterion comprises at least one of the following parameters: degree of concealment of the face, viewing angle.

7. The self-service terminal (100) as claimed in any of claims 1 to 6, wherein the self-service terminal (100) is an automated teller machine, a self-service checkout or a self-service kiosk.

8. The self-service terminal (100) as claimed in any of claims 1 to 7, wherein the storage device (108) is configured to store the image region of the at least one digital image (104) in an image database.

9. The self-service terminal (100) as claimed in claim 8, wherein the storage device (108) is furthermore configured for storing a time of day at which the image was detected by means of the imaging device (102) and/or a procedure number assigned to the image region in conjunction with the image region in the image database.

10. The self-service terminal (100) as claimed in any of claims 1 to 9, wherein the at least one processor (110) is configured for determining whether the at least one digital image (104) comprises a face of a person by means of a facial recognition algorithm.

11. The self-service terminal (100) as claimed in any of claims 1 to 10, wherein the at least one digital image (104) is a sequence of digital images.

12. The self-service terminal (100) as claimed in claim 11, wherein the processor (110) is configured to process the sequence of images and to provide a sequence of image regions, and wherein the storage device (108) is configured to store the sequence of image regions.

13. The self-service terminal (100) as claimed in any of claims 1 to 12, wherein the storage device (108) comprises a non-volatile memory for storing the image region of the at least one digital image (104).

14. A method for operating a self-service terminal (100), comprising:
detecting at least one digital image (104);
determining whether the at least one digital image (104) comprises a face of a person;
if the at least one digital image (104) comprises the face of the person, cutting out from the at least one digital image (104) an image region which comprises the face of the person; and
storing the cut-out image region of the at least one digital image (104).

15. The method as claimed in claim 16, wherein the cut-out image region of the at least one digital image (104) is stored in a non-volatile memory.
